(19) United States
(12) Patent Application Publication
(10) Pub. No.: US 2006/0197011 A1
(43) Pub. Date: Sep. 7, 2006

(54) Image forming apparatus

(75) Inventor: Masaki Hachisuga, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/284,954

(22) Filed: Nov. 23, 2005

(30) Foreign Application Priority Data
Mar. 3, 2005 (JP) 2005-059692

(51) Int. Cl. H01J 3/14; H01J 5/16

(52) U.S. Cl. 250/216

(57) ABSTRACT

An image forming apparatus includes an image carrier where an image is formed, an arrayed light source, located opposite to the image carrier, where plural light emitting devices are arrayed, an optical system, located between the arrayed light source and the image carrier, that gathers light from the light emitting devices on the image carrier, and a light diffusion unit, located between the optical system and the image carrier, that diffuses incident light.

### BACKGROUND OF THE INVENTION

1. Field of the Invention

The present invention relates to an image forming apparatus for gathering light from light emitting devices on an image carrier via an optical system.

2. Description of the Related Art

In image forming apparatuses, image density unevenness (line) may occur due to disarrangement of lens array, variation of distribution of reflective index and the like. To prevent such image density unevenness, the distribution of light-emission intensity or the like of light emitting devices may be measured, by a light quantity sensor or the like, as a basis of exposure correction, and light quantities of the respective light emitting devices may be corrected based on the result of measurement.

However, since it is very difficult to accurately bring the position of a light quantity sensor or the like during measurement into correspondence with that of a photoconductor as an actual photoreception surface, the photoreception surface is frequently shifted from an ideal image surface position. Thus, in some cases, the image density unevenness (line) cannot be resolved even by correction.

### SUMMARY OF THE INVENTION

The present invention has been made in view of the above circumstances and provides an image forming.

According to an embodiment of the present invention, it provides an image forming apparatus including: an image carrier where an image is formed; an arrayed light source, located opposite to the image carrier, where plural light emitting devices are arrayed; an optical system, located between the arrayed light source and the image carrier, that gathers light from the light emitting devices on the image carrier; and a light diffusion unit, located between the optical system and the image carrier, that diffuses incident light.

### BRIEF DESCRIPTION OF THE DRAWINGS

Embodiments of the present invention will be described in detail based on the following figures, wherein:

FIG. 1 is a schematic cross-sectional view showing the structure of an image forming apparatus according to a first embodiment of the present invention;

FIG. 2 is a perspective view of an LED print head according to the first embodiment of the present invention;

FIG. 3 is a cross-sectional view of the LED print head according to the first embodiment of the present invention corresponding to a line 3-3 in FIG. 2 (positioning pins are not shown);

FIG. 4 is an exploded semi-cross-sectional perspective view of a rod lens array and a light diffusion film according to the first embodiment of the present invention;

FIG. 5 is a graph showing the result of measurement of Examination 1;

FIG. 6 is a graph showing the result of measurement of Examination 2; and

FIG. 7 is a cross-sectional view of the LED print head according to a third embodiment of the present invention.

### DETAILED DESCRIPTION OF THE INVENTION

Hereinbelow, a first embodiment of an image forming apparatus according to the present invention will be described in accordance with the accompanying drawings.

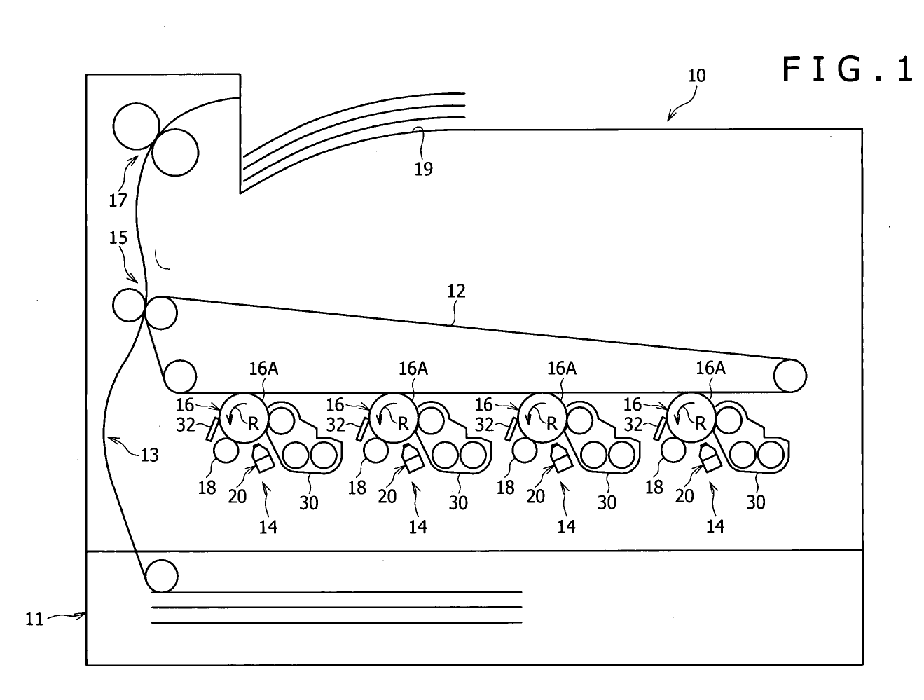

As shown in FIG. 1, an image forming apparatus 10 is a so-called tandem-type image forming apparatus. The image forming apparatus 10 has a substantially-horizontally placed intermediate transfer belt 12, and four image forming units 14 corresponding to different developing colors below the intermediate transfer belt 12.

Further, a paper tray 11 is provided below the image forming units 14, and a conveyance passage 13 extending upward from the paper feeding side of the paper tray 11 passes through a secondary transfer unit 15 in contact with the intermediate transfer belt 12 and a fixing unit 17 having a fixing device, to a discharge opening. A paper exit tray 19 is provided outside the discharge opening.

The image forming units 14 respectively have a photoconductor 16, a charger 18, an LED print head 20 as an exposure unit, a developer 30 and a cleaner 32.

The photoconductor 16 has a cylindrical outer peripheral surface as a photoreception surface 16A, on which an electrostatic latent image is formed. The photoreception surface 16A is in contact with the intermediate transfer belt 12 on the downstream side from the developer 30 in a photoconductor-rotational direction (arrow R direction).

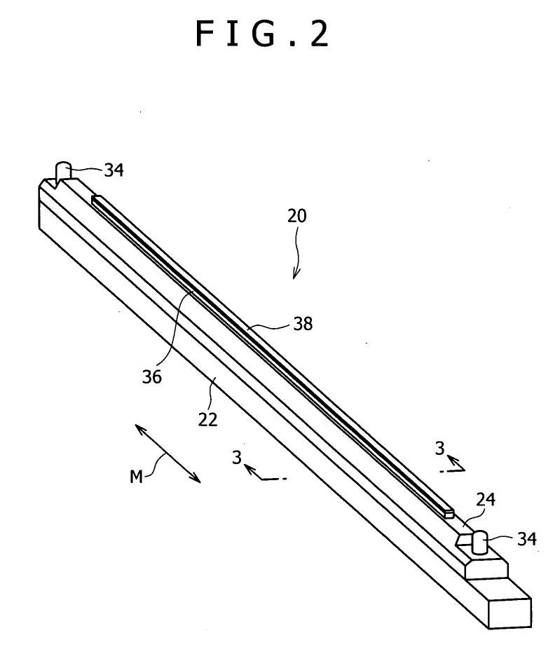

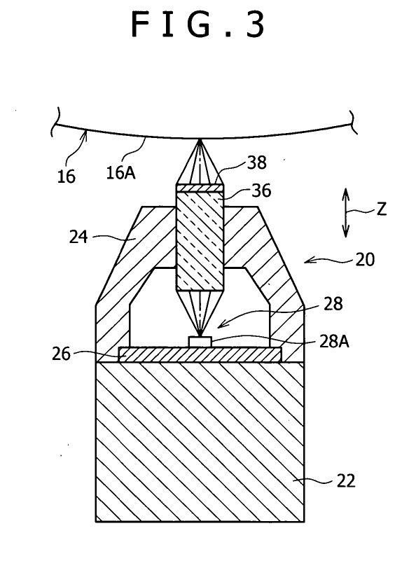

As shown in FIG. 2, the LED print head 20 has a long base member 22, to which a lens holder 24 is attached. As shown in FIG. 3, a base plate 26 is attached to the base member 22. An LED array 28 as an arrayed light source is mounted on the base plate 26. The LED array 28 has LEDs 28A as light emitting devices one-dimensionally arrayed along a lengthwise direction (arrow M direction in FIG. 2) of the base member 22. The LEDs 28A are provided in correspondence with the number of pixels (the number of dots) corresponding to the resolution.

Further, a circuit to supply various signals to control driving of the LED array 28 (respective LEDs 28A), for sequentially processing image data by 1 line, is formed on the base plate 26.

In the LED array 28 located opposite to the photoconductor 16, the LEDs 28A opposed to the photoreception surface 16A emit light based on image data transferred from a controller (not shown). The photoreception surface 16A is exposed by the light emission from the LEDs 28A, and an electrostatic latent image corresponding to image data for 1 line is formed on the photoreception surface 16A of the photoconductor 16.

As shown in FIG. 2, positioning pins 34 are provided around both ends in a lengthwise direction of the lens holder 24. The LED print head 20 is biased with a spring (not shown) to a projecting direction of the positioning pins 34, and tips of the positioning pins 34 come into contact with a positioning contact surface (not shown), thereby the positional relation with respect to the photoreception surface 16A (FIG. 3) of the photoconductor 16 is determined.

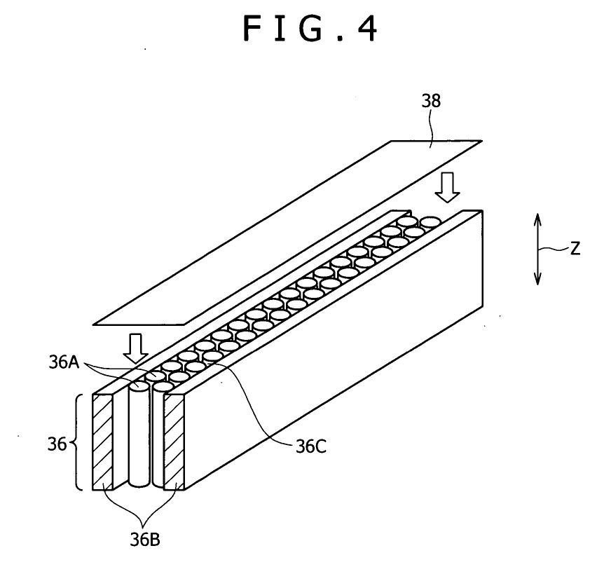

A rod lens array 36 as an optical system is attached to the lens holder 24 along the same direction as the lengthwise direction (arrow M direction) of the base member 22. The rod lens array 36 has a large number of arrayed lenses 36A (FIG. 4). As shown in FIG. 3, the rod lens array 36 is located between the LED array 28 and the photoconductor 16 so as to gather light from the LEDs 28A on the photoconductor 16.

As shown in FIG. 4, the plural lenses 36A of the rod lens array 36 are rod-type thick lenses each having a distribution of reflective index in a radial direction of its cross section. These lenses 36A are regularly alternately arranged between two frames 36B of FRP (Fiber Reinforced Plastic) or the like. The gap between the lenses 36A is filled with black silicon resin 36C or the like to prevent leakage of light.

A light diffusion film 38 as a light diffusion unit is attached to the surface of the lens 36A (light emitting surface) of the rod lens array 36. The light diffusion film 38, having a transmitting light diffusion layer, diffuses incident light. As the light diffusion layer, a layer including at least one of fluorine contained resin, silicone resin and polyolefin resin may be employed.

Further, in the light diffusion layer, as the Hayes value calculated by (diffusion transmission/entire light transmission) ×100(%), 4%≦H≦30%, or, 8%≦H≦20% may hold, or 10%≦H≦15% may hold better. When 4%≦H holds, the beam diameter may be enlarged and the focal depth may be increased. When H≦30% holds, a necessary light gathering operation may be ensured.

Next, the operation of the above embodiment will be described.

In the image forming units 14 in FIG. 1, the cleaner 32, the charger 18, the LED print head 20 and the developer 30 perform cleaning processing, charging processing, exposure processing and developing processing for the photoconductor 16 to form an image. The image is primary-transferred onto the intermediate transfer belt 12, then secondary-transferred onto a print sheet with the secondary transfer unit 15, then the image is fixed onto the print sheet with the fixing unit 17, and is discharged to the paper exit tray 19.

In the above exposure processing, as shown in FIG. 3, light from the respective LEDs 28A is gathered on the photoreception surface 16A of the photoconductor 16 via the rod lens array 36 and the light diffusion film 38. At this time, the light diffusion film 38 attached to the surface of the lenses 36A of the rod lens array 36 (FIG. 4) diffuses incident light and enlarges the beam diameter. As a result, the focal depth related to the image density unevenness is increased, and even when the photoreception surface 16A is shifted from an ideal image surface position in an optical axis direction (arrow Z direction), the occurrence of image density unevenness can be suppressed.

(Examination 1)

To confirm the operation of the above embodiment, a comparative example has been performed using an image forming apparatus according to a practical example (hereinbelow, “practical example”) and an image forming apparatus according to a comparative example (hereinbelow, “comparative example”).

The practical example has a similar structure to that of the above-described embodiment, where the light diffusion layer is located between the rod lens array and the photoconductor. In the comparative example, the light diffusion film is removed from the above embodiment, i.e., no light diffusion layer exists between the rod lens array and the photoconductor.

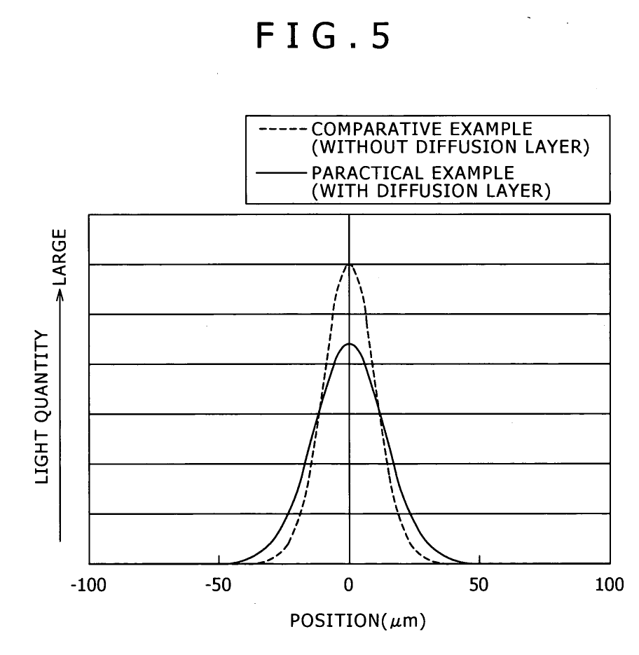

In the practical example and the comparative example, a beam profile of light toward the position of the photoconductor is measured. FIG. 5 shows the results of measurement. In FIG. 5, the horizontal axis indicates the position from the center of the beam in a beam diameter direction when the beam center is 0, with one side as a negative side while the other side as a positive side. The vertical axis indicates the light quantity of the above light. As shown in FIG. 5, in the practical example, the beam diameter is larger than that in the comparative example.

(Examination 2)

To confirm the operation of the above embodiment, an examination to compare the respective focal depths in the practical example and the comparative example used in the Examination 1 has been performed.

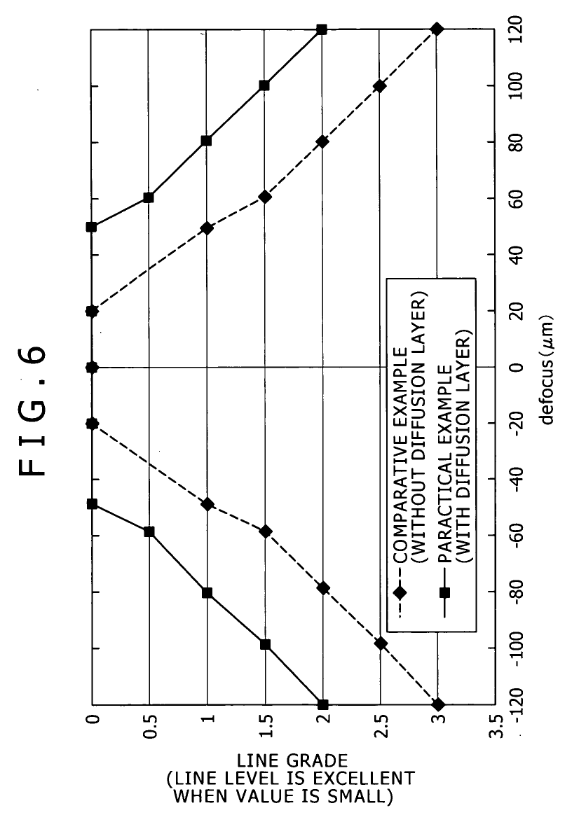

In the practical example and the comparative example, the position of the photoreception surface of the photoconductor with respect to the LED print head is shifted in the optical axis direction, and the status of occurrence of line unevenness after development is observed in each shifted position. FIG. 6 shows the results of measurement.

In FIG. 6, the horizontal axis indicates the positional relation in the optical axis direction when the focusing position is 0, with the side where the position of the photoreception surface with respect to the print head is close from the focusing position as a negative side, while the side where the position of the photoreception surface with respect to the print head is far from the focusing position as a positive side. The vertical axis indicates the degree of line unevenness by visual evaluation by grade (Line GRADE). It is understood that the smaller the value is, the lower the degree of line unevenness is (image is excellent).

For example, assuming that the range of Line GRADEs 0 to 1 corresponds to an allowable range for image formation, the allowable range of shift in the optical axis direction in the comparative example is −50 μm to +50 μm, while that in the practical example is −80 μm to +80 μm, as shown in FIG. 6. Thus, it has been shown that the focal depth is deeper than that in the comparative example.

From the Examinations 1 and 2, it is understood that in the practical example, the beam diameter is larger than that in the comparative example, and in correspondence with the increase of beam diameter, the occurrence of image density unevenness (line unevenness) can be reduced.

Next, a second embodiment of the image forming apparatus will be described. In the first embodiment, as shown in FIG. 4, the light diffusion film 38 is attached to the surface of the lens 36A (light emitting surface) of the rod lens array 36, however, in the second embodiment, the surface of the lens 36A (light emitting surface) of the rod lens array 36 is covered with a light diffusion layer. The light diffusion layer is formed by coating the surface of the lens 36A (light emitting surface) with a coating material including at least one of fluorine contained resin, silicone resin and polyolefin resin. Note that as the other constituent elements are the same as those of the first embodiment, the explanations thereof will be omitted.

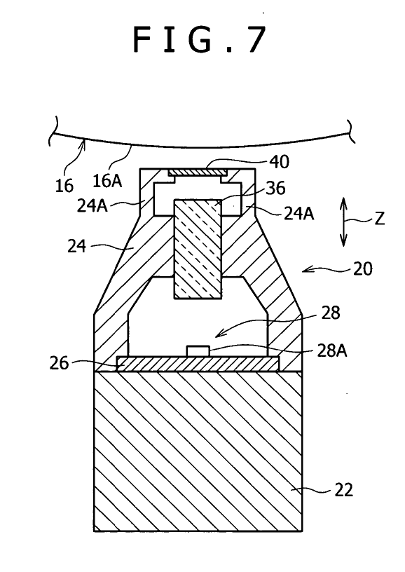

Next, a third embodiment of the image forming apparatus will be described with reference to FIG. 7. In the third embodiment, a light diffusion plate 40 as the light diffusion unit having a light diffusion layer is located between the rod lens array 36 and the photoconductor 16. As the other constituent elements are the same as those of the first embodiment, those elements have the same reference numerals and the explanations thereof will be omitted.

As shown in FIG. 7, on the photoconductor 16 side of the lens holder 24, light diffusion plate supporting members 24A are provided upright on the both sides of the rod lens array 36. The light diffusion plate supporting members 24A support the light diffusion plate 40 from lateral directions.

The light diffusion plate 40 is formed by forming a light diffusion layer (a layer including at least one of fluorine contained resin, silicone resin and polyolefin resin) on a transparent support member of resin or glass. The light diffusion plate 40 is placed in a position away from the rod lens array 36, attachably/removably to/from the light diffusion plate support members 24A.

In the present embodiment, the light diffusion layer of the light diffusion plate 40 diffuses incident light to enlarge the beam diameter and increase the focal depth. Note that as the light diffusion plate 40 is provided between the rod lens array 36 and the photoconductor 16, toner dropped from the photoconductor 16 can be received on not the rod lens array 36 but the light diffusion plate 40. Accordingly, it is not necessary to clean the rod lens array 36. Further, as the light diffusion plate 40 is attachable/removable to/from the light diffusion plate support members 24A, cleaning work to remove toner on the light diffusion plate can be easily performed.

Note that in the above-described embodiments, the image forming apparatus is a so-called tandem color image forming apparatus, however, any other image forming apparatus such as a so-called 4-cycle image forming apparatus or a monochrome image forming apparatus can be employed.

Further, in the above-described embodiments, the rod lens array is employed as the optical system of the present invention since the focal depth in the conventional print head having a rod lens array is very small. However, another lens array or the like may be employed as the optical system of the present invention.

According to the embodiments of the present invention, there is provided an image forming apparatus including: an image carrier where an image is formed; an arrayed light source, located opposite to the image carrier, where plural light emitting devices are arrayed; an optical system, located between the arrayed light source and the image carrier, that gathers light from the light emitting devices on the image carrier; and a light diffusion unit, located between the optical system and the image carrier, that diffuses incident light.

According to an aspect of the present invention, the light from the respective light emitting devices is gathered on the image carrier via the optical system and the light diffusion unit. At this time, the light diffusion unit diffuses the incident light to enlarge the beam diameter and emits the light toward the image carrier. In this arrangement, even when the position of a photoreception surface is shifted, the variation of light quantity may be reduced.

Further, according to another aspect of the present invention, the light diffusion unit may be a light diffusion layer coated on a surface of a lens of the optical system.

According to the above aspect of the present invention, the light diffusion layer coated on the surface of the lens of the optical system diffuses the incident light.

Further, according to another aspect of the present invention, the light diffusion unit may be a light diffusion film having the light diffusion layer attached to the surface of the lens of the optical system.

According to the above aspect of the present invention, the light diffusion layer of the light diffusion film attached to the surface of the lens of the optical system diffuses the incident light.

Further, according to another aspect of the present invention, the light diffusion unit may be a light diffusion plate having the light diffusion layer.

According to the above aspect of the present invention, the light diffusion layer of the light diffusion plate diffuses the incident light.

As described above, according to the present invention, even when the attachment position of the light emitting devices and that of the image carrier are shifted from each other, the occurrence of image density unevenness may be suppressed.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-059692 filed on Mar. 3, 2005 including specification, claims, drawings and abstract is incorporated herein by reference in its entirety.

What is claimed is:

1. An image forming apparatus comprising:
an image carrier where an image is formed;
an arrayed light source, located opposite to the image carrier, where a plurality of light emitting devices are arrayed;
an optical system, located between the arrayed light source and the image carrier, that gathers light from the light emitting devices on the image carrier; and
a light diffusion unit, located between the optical system and the image carrier, that diffuses incident light.

2. The image forming apparatus according to claim 1, wherein the light diffusion unit is a light diffusion layer coated on a surface of a lens of the optical system.

3. The image forming apparatus according to claim 1, wherein the light diffusion unit is a light diffusion film having the light diffusion layer attached to the surface of the lens of the optical system.

4. The image forming apparatus according to claim 1, wherein the light diffusion unit is a light diffusion plate having the light diffusion layer.
